(19) United States
(12) Patent Application Publication
(10) Pub. No.: US 2006/0191586 A1
(43) Pub. Date: Aug. 31, 2006

(54) Double-layer explosion-proof braided hose structure and manufacturing method thereof

(76) Inventor: Hung-Lin Cheng, Caotun Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/360,483

(22) Filed: Feb. 24, 2006

(30) Foreign Application Priority Data
Feb. 25, 2005 (TW) 094105920

(51) Int. Cl. F16L 11/00

(52) U.S. Cl. 138/127

(57) ABSTRACT

The present invention discloses a double-layer explosion-proof braided hose structure and manufacturing method thereof. The present invention uses a vulcanized rubber hose as a principal part of explosion-proof hose, and sequentially forms the first braided layer, the heatproof glue layer and the second braided layer on surface of the vulcanized rubber hose. Then, a heating renovation procedure is performed to form a double-layer explosion-proof braided hose. After the heating renovation procedure, the first braided layer, the heatproof glue layer and the second braided layer will be firmly combined. Furthermore, the present invention can also simplify the manufacturing procedure and save the installation time to overcome the disadvantages of the prior art.

### BACKGROUND OF INVENTION

1. Field of the Invention

The invention relates to a double-layer explosion-proof braided hose structure and manufacturing method thereof, and more particularly, to a double-layer explosion-proof braided hose structure and manufacturing method thereof that manufactured with the vulcanized rubber hose.

2. Description of the Prior Art

The explosion-proof hoses are generally applied on high pressure or high danger environment, such as gas line, telecommunication or petrifaction, to protect the operators. For example, for preventing dangers caused by the spark of electricity or the high temperature, the dangerous environment always has the explosion-proof electric appliances and uses the explosion-proof hoses in the transportation. For further explaining the conventional technology of the explosion-proof hose, the detail structure and manufacturing method are described as follows.

Please refer to FIG. 1 and FIG. 2 together. FIG. 1 is a schematic diagram of structure of an explosion-proof hose according to the prior art, and FIG. 2 is a manufacturing flowchart of an explosion-proof hose according to the prior art. First, the step S2 is performed, wherein the raw rubber is used to form a raw rubber extrusion hose 12 with the integrated technology. Then the steps S4, S6, S8 and S10 are performed. A first steel wire 14 is sequentially braided outside the raw rubber extrusion hose 12, and a raw rubber tape 16 is then wound outside the first steel wire 14. After that a heatproof cloth is wound outside the raw rubber tape 16, the second steel wire 18 is sequentially braided outside the raw rubber tape. Then, the step S12 is performed to vulcanize the structure obtained in the step S10, and the first steel wire 14, the raw rubber tape 16 and the second steel wire 18 will melt and combine together to make whole double-layer explosion-proof braided hose 10 having the explosion-proof ability. Finally, the step S14 and S16, taking off the heatproof glue, and getting a double-layer explosion-proof braided hose. However, the first steel wire 14 or the second steel wire 18 is a stiff steel wire having elasticity, if the double-layer explosion-proof braided hose 10 is cut, the braided steel wires will irregularly curve and make the double-layer explosion-proof braided hose 10 hard to install.

### SUMMARY OF INVENTION

It is therefore a primary objective of the claimed invention to provide a double-layer explosion-proof braided hose structure and manufacturing method thereof that can simplify the manufacturing procedure and save the installation time to overcome the disadvantages of the prior art.

It is therefore another objective of the claimed invention to provide a double-layer explosion-proof braided hose structure and manufacturing method thereof that the heatproof glue layer is placed between the first braided layer and the second braided layer. After the heating renovation procedure, the first braided layer, the heatproof glue layer and the second braided layer will be firmly combined.

According to the claimed invention, the double-layer explosion-proof braided hose structure and manufacturing method thereof include the steps of sequentially braiding and winding a first braided layer, a heatproof glue layer and a second braided layer on surface of a vulcanized rubber hose. Then a heating renovation procedure is performed to combine the vulcanized rubber hose, the first braided layer, the heatproof glue layer and the second braided layer, and form a double-layer explosion-proof braided hose.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of structure according to the prior art.

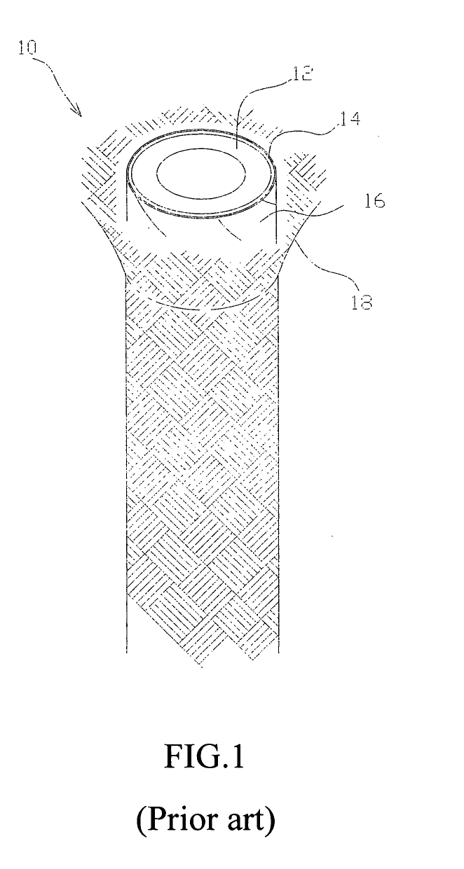

FIG. 2 is a manufacturing flowchart according to the prior art.

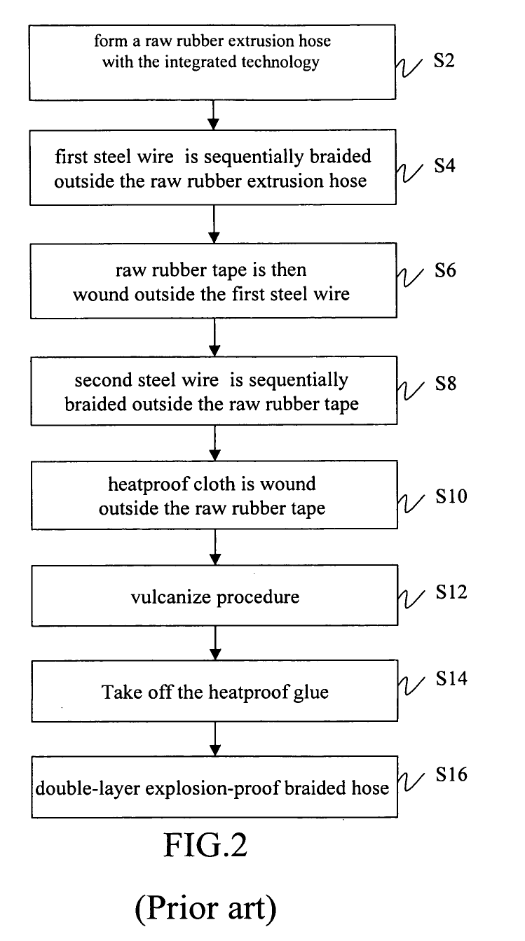

FIG. 3 is a schematic diagram of structure according to the present invention.

FIG. 4 is a top view of structure according to the present invention.

FIG. 5 is a manufacturing flowchart according to the present invention.

10 double-layer explosion-proof braided hose
12 raw rubber extrusion hose
14 first steel wire
16 raw rubber tape
18 second steel wire
40 double-layer explosion-proof braided hose
42 shaped vulcanized rubber hose
44 first braided layer
46 heatproof glue layer
48 second braided layer

### DETAILED DESCRIPTION

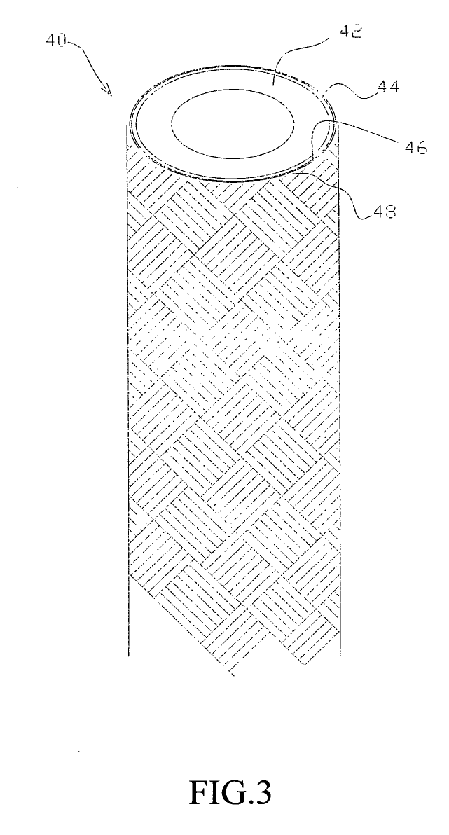

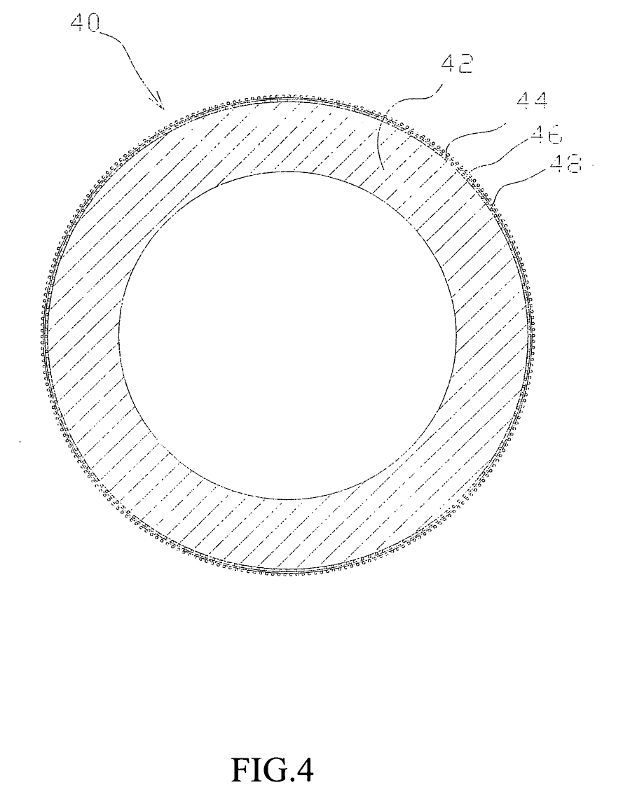

Please refer to FIG. 3 and FIG. 4, where are a schematic diagram and a top view of structure according to the present invention.

The present structure of double-layer explosion-proof braided hose 40, from inner toward outer, includes a shaped vulcanized rubber hose 42, a first braided layer 44, a heatproof glue layer 46 and a second braided layer 48. The first braided layer 44, the heatproof glue layer 46 and the second braided layer 48 are braided and wound on surface of the shaped vulcanized rubber hose 42, the first braided layer 44 and the heatproof glue layer 46 with a braiding and winding technology. In this embodiment, the shaped vulcanized rubber hose 42 is integrated manufactured, the first braided layer 44 and the second braided layer 48 are braided with steel wires, and the heatproof glue layer 46 is an environment-protective heatproof glue layer, such as a heatproof nylon tape, so that the structure of a double-layer explosion-proof braided hose 40 is formed.

The structure of the double-layer explosion-proof braided hose 40 has the first braided layer 44 and the second braided layer 48, so that it can have the effect of high-pressure proof. In addition, with a heating renovation procedure, the first braided layer 44, the heatproof glue layer 46 and the second braided layer 48 will be firmly combined to make the structure of the double-layer explosion-proof braided hose 40 having effects of heatproof and high-pressure proof.

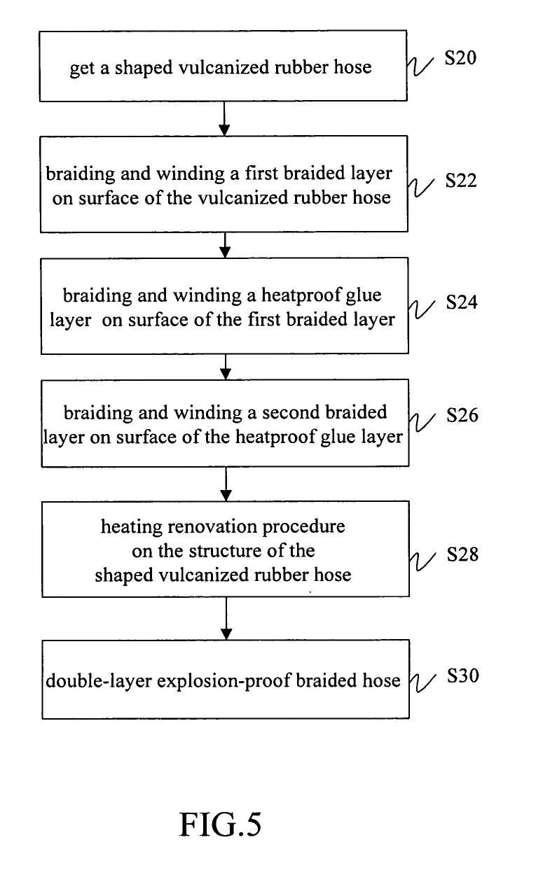

After explaining the structure of the double-layer explosion-proof braided hose 40, a manufacturing flow will be continuously described with FIG. 5, which is a manufacturing flowchart according to the present invention. First of all, a step S20 is performed that the integrated manufactured rubber hose is vulcanized to get a shaped vulcanized rubber hose 42. Then, the step S22 is performed that braiding and winding a first braided layer 44 on surface of the vulcanized rubber hose 42. Then, the step S24 is performed that braiding and winding a heatproof glue layer 46 on surface of the first braided layer 44. In this embodiment, the heatproof glue layer 46 is a heatproof nylon tape (environment-protective heatproof glue layer). Then the step S26 is performed that braiding and winding a second braided layer 48 on surface of the heatproof glue layer 48. In this embodiment, the first braided layer 44 and the second braided layer 48 are braided with steel wires. Finally, the steps S28 and S30 are performed that performing a heating renovation procedure on the structure of the shaped vulcanized rubber hose 42, the first braided layer 44, the heatproof glue layer 46 and the second braided layer 48, so that the structure of the shaped vulcanized rubber hose 42, the first braided layer 44, the heatproof glue layer 46 and the second braided layer 48 will be firmly combined to form a double-layer explosion-proof braided hose 40.

After the heating renovation procedure on the double-layer explosion-proof braided hose 40, the first braided layer 44, the heatproof glue layer 46 and the second braided layer 48 will be firmly combined. Furthermore, the present invention can also simplify the manufacturing procedure and save the installation time to overcome the disadvantages of the prior art.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. a double-layer explosion-proof braided hose structure, comprising:
a vulcanized rubber hose;
a first braided layer braided and wound on surface of the vulcanized rubber hose;
a heatproof glue layer braided and wound on surface of the first braided layer; and
a second braided layer braided and wound on surface of the heatproof glue layer to form a double-layer explosion-proof braided hose.

2. The double-layer explosion-proof braided hose structure of claim 1, wherein the first braided layer and the second braided layer are braided with a steel wire.

3. The double-layer explosion-proof braided hose structure of claim 1, wherein the vulcanized rubber hose is integrated.

4. The double-layer explosion-proof braided hose structure of claim 1, wherein the heatproof glue layer is an environment-protective heatproof glue layer.

5. The double-layer explosion-proof braided hose structure of claim 4, wherein the environment-protective heatproof glue layer is a heatproof nylon tape.

6. The double-layer explosion-proof braided hose structure of claim 1, wherein the double-layer explosion-proof braided hose is processed by a heating renovation procedure.

7. A manufacturing method of double-layer explosion-proof braided hose, comprising:
braiding and winding a first braided layer on surface of a vulcanized rubber hose;
braiding and winding a heatproof glue layer on surface of the first braided layer;
braiding and winding a second braided layer on surface of the heatproof glue layer; and
performing a heating renovation procedure to form a double-layer explosion-proof braided hose.

8. The manufacturing method of double-layer explosion-proof braided hose of claim 7, wherein material of the first braided layer and the second braided layer is a steel wire.

9. The manufacturing method of double-layer explosion-proof braided hose of claim 7, wherein the vulcanized rubber hose is integrated.

10. The manufacturing method of double-layer explosion-proof braided hose of claim 7, wherein the heatproof glue layer is an environment-protective heatproof glue layer.

11. The manufacturing method of double-layer explosion-proof braided hose of claim 10, wherein the environment-protective heatproof glue layer is a heatproof nylon tape.
